(19) United States
(12) Patent Application Publication
(10) Pub. No.: US 2009/0090306 A1
(43) Pub. Date: Apr. 9, 2009

(54) MOBILE EQUINE ASSISTANT

(76) Inventor: Marc Miles, Energy, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/248,605

(22) Filed: Oct. 9, 2008

Related U.S. Application Data
(60) Provisional application No. 60/998,155, filed on Oct. 9, 2007.

(51) Int. Cl. A01K 1/06; A01K 15/04

(52) U.S. Cl. 119/732; 119/752

(57) ABSTRACT

A mobile support apparatus for an animal comprising an adjustable frame for securing the animal in position, a tailgate assembly for preventing egress of a secured animal from the adjustable frame and protects an individual positioned at the posterior of the secured animal, an adjustable head support, a hydraulic system for adjusting the frame and at least one pair of wheels. The support apparatus may further comprise a power supply for powering the hydraulic system and a storage compartment.

### CROSS REFERENCE TO RELATED APPLICATIONS

This application claims the benefit of provisional application Ser. No. 60/998,155, filed Oct. 9, 2007, which is incorporated herein by reference.

### BACKGROUND OF THE INVENTION

The invention relates generally to a device used in veterinary procedures and more specifically a mobile support device for a horse that allows a veterinarian to perform a number of procedures on the animal, while the animal is safely and effectively supported. The device is automated and fully adjustable to accommodate animals of different sizes. Furthermore, it allows for safe and humane handling of sedated animals.

Veterinarians who treat large animals, particularly horses, are called upon to perform a myriad of procedures related to the health and maintenance of the animal. These include treatment of the horse's feet, shoeing, care of the teeth and reproductive procedures, such as artificial insemination. There has long been a need for a device that can safely and effectively secure the horse in an appropriate position to receive the required treatment or procedure that also allows optimum access by the veterinarian while affording him a safe work environment. Such as device should be mobile so that it can be transported to the site of the animal.

### SUMMARY OF THE INVENTION

A mobile support apparatus for a horse or other animal that allows a veterinarian to perform a number of different procedures on the animal, while the animal is safely and effectively secured while affording the veterinarian safe and effective access to the animal. The device safely and humanely restrains and supports the animal, is automated, and fully adjustable to accommodate animals of different sizes.

### BRIEF DESCRIPTION OF THE DRAWINGS

FIG. 1 is side elevational view of the apparatus in use;

FIG. 2 is a side elevational view of the apparatus;

FIG. 3 is a review plan view of the apparatus;

FIG. 4 is a rear perspective view of the apparatus;

FIG. 6 is a front plan view;

FIG. 7 is a perspective view of the head rest assembly;

FIG. 8A is a front perspective view of the chest gate; and

FIG. 8B is a front perspective of the chest gate with the handle and lock assembly exposed.

### DETAILED DESCRIPTION

The apparatus of the present is indicated generally in the figures as reference number 20. Apparatus 20 includes a frame 22 with major components including a first or front vertical strut 23, a first main vertical strut 24 and a second main vertical strut 25, a hitch arm 26 and trailer hitch 27 at the front end and a pair of wheels 28 at the rear end to provide for mobility. The apparatus can be attached to a tow vehicle and moved to the site of use.

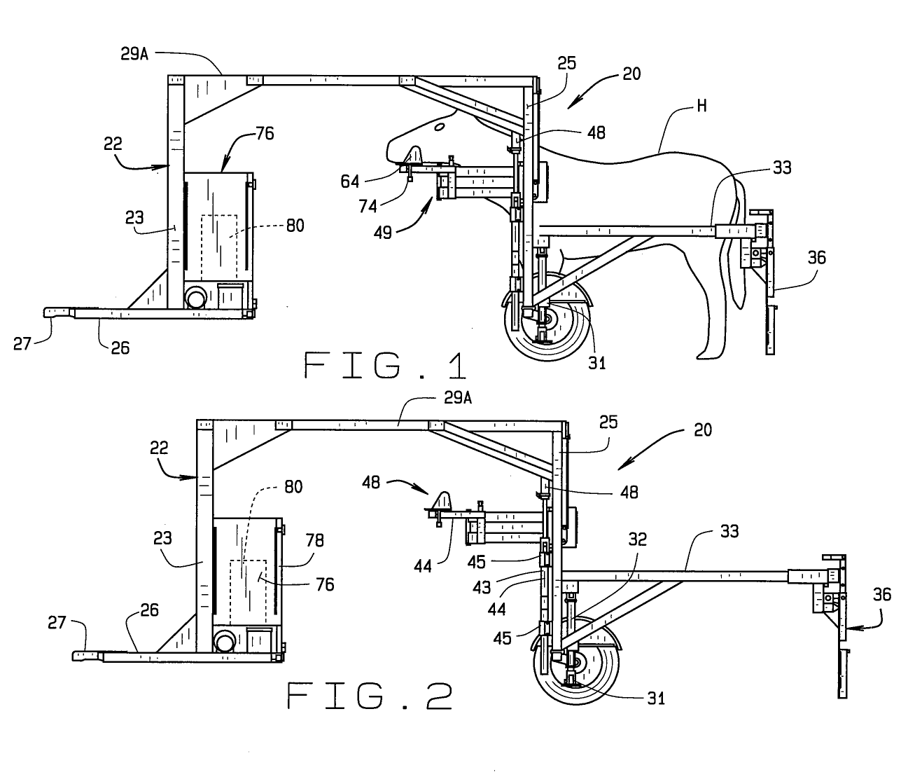

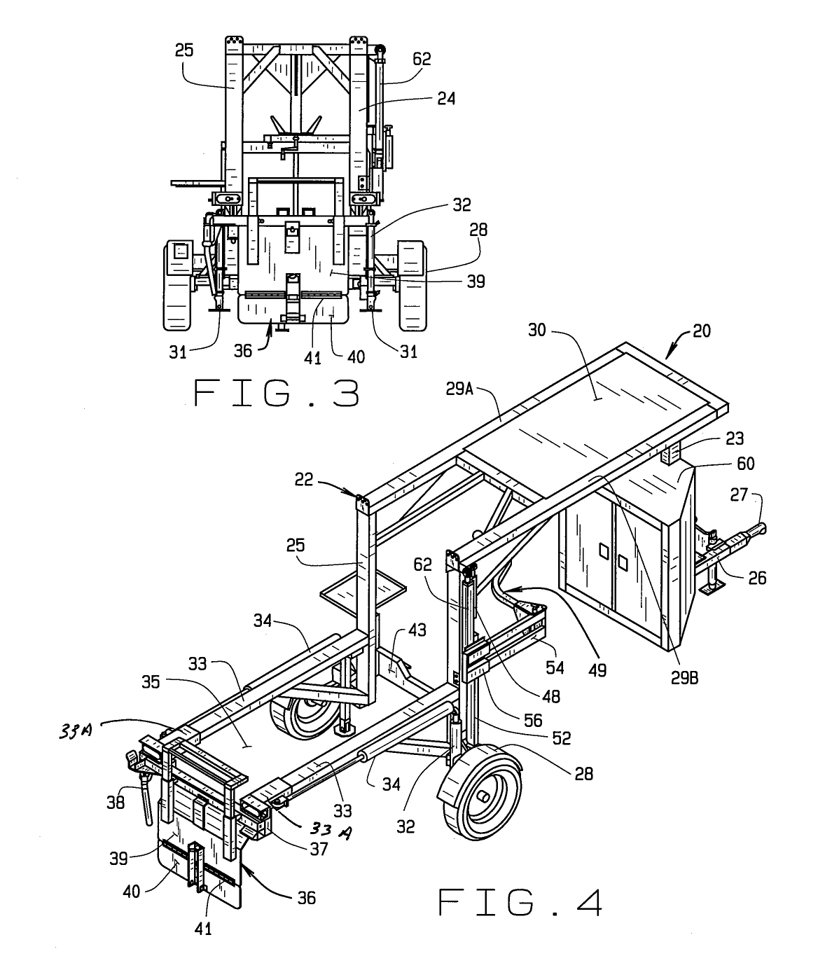

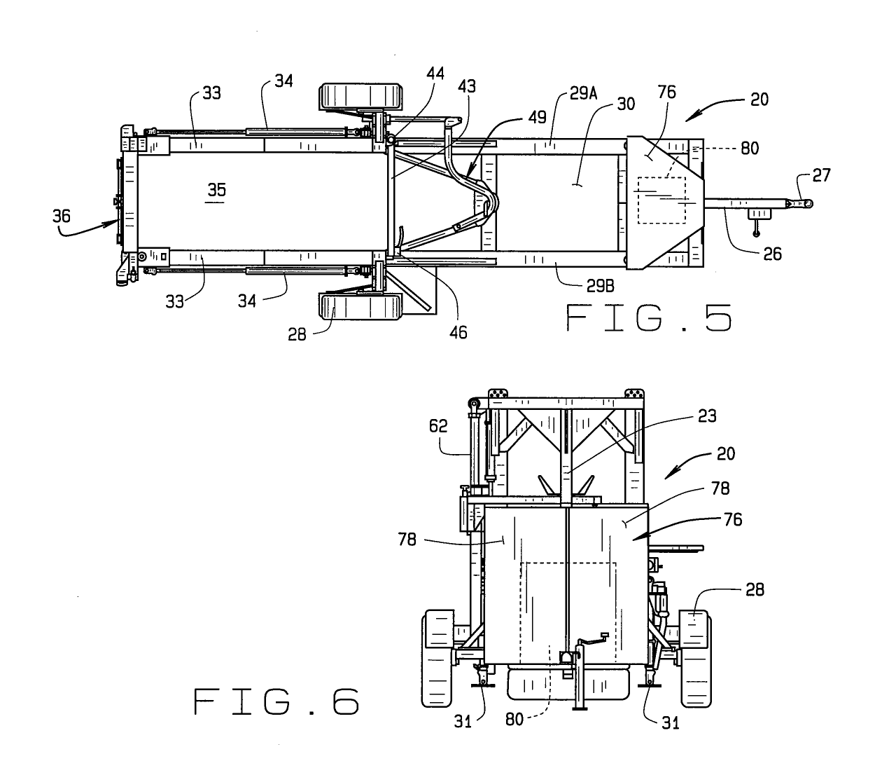

Frame 22 includes horizontal top struts 29A and 29B with a flat roof 30 to provide shelter. The vertical main struts 24 and 25 can include hydraulically actuated legs 31 that extend out of the struts for stabilization. The legs can be extended by a hydraulic system that includes cylinders 32. Each leg 31 is independently adjustable so the apparatus can be stabilized on uneven surfaces. There is a pair of opposed horizontal frame members 33, which can be referred to as rails or guides,that are comprised of slidingly engaged members 33A that allow a tail gate assembly, which will be discussed in greater detail below, to be moved forward and backward. The tail gate assembly can be moved forward and backward hydraulically by hydraulic cylinders 34, as seen by comparing the position of the tail gate in FIGS. 1 and 2. The side rails and tailgate assembly define an open securing chute 35 for an animal H. The hydraulic cylinders 34 extension feature allows the apparatus to safely secure an animal of any size in chute 35.

An adjustable tail gate assembly 36 depends from the ends of slideable members 33A and is attached by a hinge 37 at one side so that the tail gate can be opened by swinging to a side and closed to allow ingress and egress for the animal. This design allows for safe positioning of the veterinarian, who stays to the side of chute 35 to unlatch, open and close the tail gate assembly since the tail gate assembly rotates with at least a 90° of rotation. Hence the veterinarian does not have to stand behind the animal when opening and closing the tail gate assembly.

The tail gate assembly 36 includes a substantially flat panel 38 with a drop down flap or panel 40 connected by hinge 41. The flap can be raised or lowered, however, in the lowered position (FIG. 10) it provides a barrier to prevent a veterinarian positioned at the rear of the animal from being kicked. The tailgate assembly also includes a handle and locking assembly 42 to secure the tailgate in a closed position.

Frame 22 includes an adjustable front chest gate 43, shown in greater detail in FIGS. 8A and 8B. Gate 43 is attached to rod 44 that his hinged to the frame in brackets 45 so that gate 43 can be opened. It will be noted that rod 44 can slide vertically in brackets 45. Gate 43 has a latch or securing handle 46 on both sides. The hinged gate 43 can be swung open to allow the veterinarian or handler to walk in front of the horse and load the animal into the apparatus. Once the animal is in the apparatus, the handle can exit from the front and gate 43 can be closed and secured with the latch. With the tail gate assembly 34 and chest gate 43 closed, the animal is secured in place. Gate 43 includes a central cut-out 47 that allows for the positioning of the animals neck without placing undue pressure on the neck and keep the gate from pressing on the animal's sensitive trachea. The relative height of gate 43 can be adjusted to accommodate animals of different sizes. The positioning of the height of the gate can be controlled by hydraulic cylinder 48, which is operably attached to rod 44.

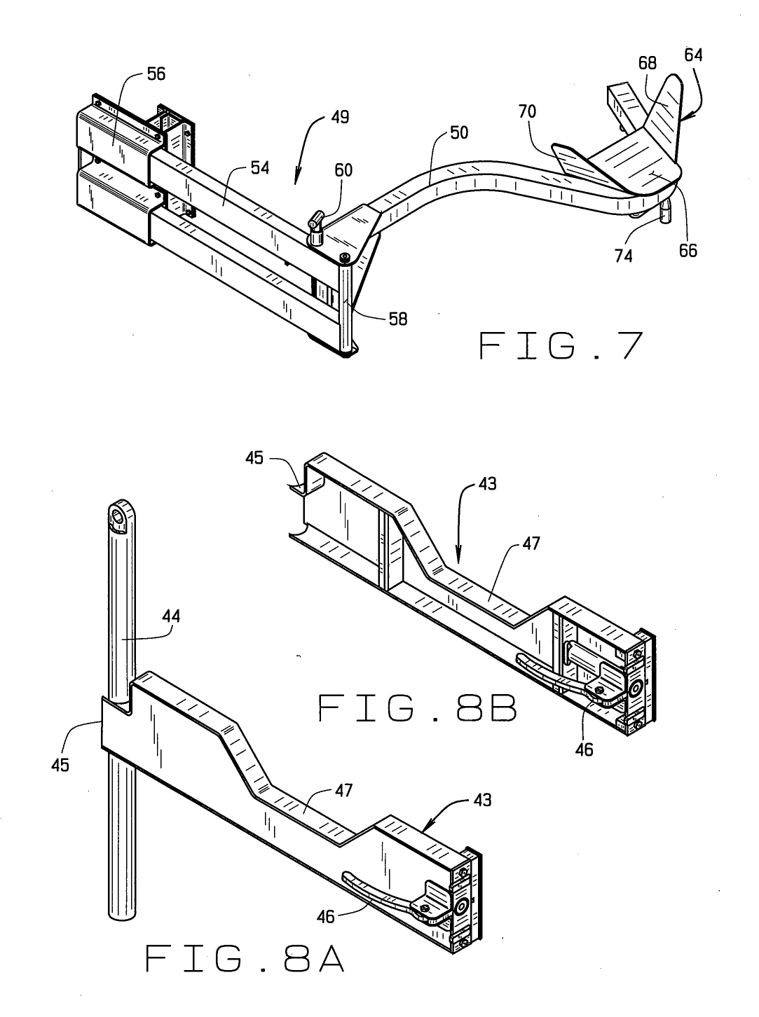

The apparatus includes a head rest assembly 49, shown in greater detail in FIG. 7, including a substantially V-shaped yoke 50 that can be raised or lowered to accommodate animals of different heights and to allow a veterinarian to sit or stand while working on the animal's head or teeth. Yoke 50 can be connected to an adjustable, vertically moveable upright 52 by slide bars 54 which are engaged a slide bracket 56. Slide bars 54 are horizontally and slidingly engaged in bracket 56 to allow for forward and rearward positioning of the yoke by sliding bars 54 back and forth in bracket 56. Yoke 50 is attached to slide bars 54 by a hinge 58 to allow the yoke to swing out of the way and the animal to be positioned. The yoke is moved back into place and tightened in place by a spring pin 60. The entire yoke assembly can be moved up and down by a hydraulic cylinder 62 attached to moveable upright 52 to position the yoke at the proper height.

There is an adjustable head rest 64 on the point of the yoke. Head rest 64 has a resting surface 66 and a pair of opposed wings 68 and 70 to provide lateral stability. Resting surface 66 and wings 68, 70 generally are padded for safety and comfort. Head rest 64 can be raised and lowered by screw jack assembly 74. Rotation of jack screw 74 allows fine tuning of the elevation of the head rest to accommodate different size animals for dental procedures for example.

The apparatus includes a storage compartment 76 secured at the front of the frame on vertical strut 23, conveniently positioned for access by the veterinarian. Storage compartment 76 is multifunctional and includes, without limitation, internal storage space for the storage of equipment, medicines and the like closed by a pair of hinged doors 78. Also, a hydraulic system, generally comprising a pump, reservoir and hydraulic lines connected to the respective hydraulic cylinders, may have operable components, such as the pump, and reservoir, indicated generally by number 80, housed in compartment 76 for actuating all of the hydraulically actuated adjustable components. The pump can be an electric pump powered by a rechargeable battery or can be plugged in to an electric outlet if one is available. The electrical system can include an a power inverter to supply 110 volts so the veterinarian can operate other auxiliary equipment such as a dental light or drills and ultrasound equipment.

It will be appreciated that the apparatus can be constructed in different configurations that incorporate the novel features to provide a mobile device for the safe and effective securing of an animal during veterinary procedures. The illustrated embodiment is one configuration representing the best mode of working the invention presently known to the inventor.

1. A support apparatus for an animal comprising:
a frame for securing the animal in a desired position;
a chest gate at a front end of the frame;
an adjustable head rest assembly at the front end of the frame;
a tailgate assembly at a rear end of the frame; and
a hydraulic system for hydraulically adjusting a vertical height of the chest gate and the head rest assembly.

2. The support apparatus for an animal of claim 1 further comprising a wheel assembly under the frame for transporting the support apparatus.

3. The support apparatus of claim 1 wherein the adjustable headrest assembly further comprises and adjustable yoke and a head rest.

4. The support apparatus of claim 3 wherein the adjustable headrest assembly further comprises a screw jack assembly for adjusting the vertical position of the head rest

5. The support apparatus of claim 1 further comprising adjustable legs for adjusting the vertical height of the front end of the frame and for stabilizing the support apparatus.

6. The support apparatus of claim 1 wherein the frame includes a first and second horizontal frame member.

7. The support apparatus of claim 5 wherein said first and second horizontal frame members include hydraulic apparatus for adjustment of a horizontal dimension of the frame.

8. The support apparatus of claim 1 further comprising a storage compartment.

9. The support apparatus of claim 4 wherein the tail gate assembly further comprises an upper panel and a lower panel movably attached to the upper panel by a transverse hinge.

10. A support apparatus for an animal comprising:
a frame having a front end and a rear end, a first lateral horizontal frame member and an opposed second lateral horizontal frame member;
a chest gate at the front end of the frame;
an adjustable head rest assembly at the front end of the frame;
a tailgate assembly at a rear end of the frame;
a first adjustable leg at the front of the frame;
a second adjustable leg at the front end of the frame;
a wheel assembly under the frame; and
a hydraulic system for hydraulically adjusting a vertical height of the front end of the frame, the head rest assembly and the first and second adjustable legs.

11. The support apparatus of claim 9 further comprising apparatus at the front end of the frame for securing the support apparatus to a tow vehicle.

12. The support apparatus of claim 9 wherein the adjustable head rest assembly further comprises a vertically adjustable yoke and a head rest on the yoke.

13. The support apparatus of claim 11 further comprising a screw jack assembly between the yoke and the head rest for adjustment of the headrest.

14. The support apparatus of claim 9 wherein the first and second lateral horizontal frame members are adjustable in length.

15. A support apparatus for an animal comprising:
a frame having a front end and a rear end, a first adjustable lateral horizontal frame member and an opposed second adjustable lateral horizontal frame member;
a chest gate at the front end of the frame;
an adjustable head rest assembly at the front end of the frame;
a tailgate assembly at a rear end of the frame having an upper panel and a lower panel moveable attached to said upper panel by a hinge;
a first vertically adjustable leg at the front of the frame;
a second vertically adjustable leg at the front end of the frame;
a wheel assembly under the frame;
a tow vehicle attachment apparatus at the front end of the frame; and
a hydraulic system for hydraulically adjusting the head rest assembly, the first and second horizontal frame members and the first and second adjustable legs.

16. The support apparatus of claim 14 further comprising a storage compartment.

17. The support apparatus of claim 14 wherein said hydraulic system further comprises at least one hydraulic cylinder between said frame and said head rest assembly.

18. The support apparatus of claim 14 wherein said head rest assembly further comprises a yoke and a head rest.

19. The support apparatus of claim 17 wherein said yoke can be moved forward and backward.

20. The support apparatus of claim 17 wherein said yoke is hingedly attached to the frame whereby said yoke can be opened relative to the frame.
